(19) United States
(12) Patent Application Publication
(10) Pub. No.: US 2008/0188202 A1
(43) Pub. Date: Aug. 7, 2008

(54) APPARATUS AND METHOD FOR SYNCHRONIZING PHONEBOOK DATA WITH MESSAGES IN PORTABLE TERMINAL

(75) Inventor: Sun-Young MAENG, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/019,148

(22) Filed: Jan. 24, 2008

(30) Foreign Application Priority Data
Feb. 6, 2007 (KR) 2007-0011942

(51) Int. Cl. H04Q 7/22

(52) U.S. Cl. 455/412.1

(57) ABSTRACT

Provided is an apparatus and method for synchronizing phonebook data with messages in a portable terminal. The method includes setting a synchronization mode for synchronizing the phonebook data with the sent/received messages; detecting, from among the sent/received messages, a message corresponding to a specific phone number of a phonebook when the specific phone number is changed; and changing sending/receiving information contained in the detected message according to the set synchronization mode.

### PRIORITY

This application claims priority under 35 U.S.C. §119 to an application filed in the Korean Intellectual Property Office on Feb. 6, 2007 and assigned Serial No. 2007-11942, the contents of which are incorporated herein by reference.

### BACKGROUND OF THE INVENTION

1. Field of the Invention

The present invention relates generally to an apparatus and method for synchronizing phonebook data and messages in a portable terminal, and in particular, to an apparatus and method for changing a phone number and a name contained in a sent or received message according to a mode for synchronizing phonebook data and messages when the phonebook data is changed by the user, and displaying them.

2. Description of the Related Art

The use of portable terminals is rapidly increasing due to developments in various electronics and communications industries. In addition to main functions, portable terminals have been developed to support a variety of additional functions to meet users' demands. For example, portable terminals support a phonebook, games, schedulers, a message service, an Internet service, an e-mail service, and various other functions.

Particularly, portable terminals support a phonebook that stores a number of phone numbers and corresponding names, and a message storage box that stores sent/received messages. Thus, a name corresponding to a sender's/receiver's phone number contained in a sent/received message is also displayed by searching phone numbers stored in the phonebook when the sent/received message is displayed.

Since the portable terminals check a sender's/receiver's name of a sent/received message using stored phonebook data, information on sender/receiver (hereinafter, sending/receiving information) contained in the sent/received message is changed when the stored phonebook data is updated.

In the portable terminals according to related art, when phonebook data is changed, the changed phonebook data is used only for messages that are sent/received after a change point in time at which the phonebook data is changed. That is, senders' or receivers' phone numbers and names contained in the messages are displayed according to the changed phonebook data. However, senders' or receivers' phone numbers and names contained in messages which were sent/received before the change point are not changed. Thus, if a user attempts to perform linking operations (e.g., a reply to a received message and a call connection) associated with the messages sent/received before the change point, the linking operations are performed to unchanged senders' or receivers' phone numbers.

Therefore, the portable terminals support a method for changing sending or receiving information contained in a message which had been sent/received before the change point, according to the changed phonebook data. In this case, sender's name is removed and only sender's phone number is remained, so that a user cannot know who sent the message and which phone number the user calls.

### SUMMARY OF THE INVENTION

An aspect of the present invention is to substantially solve at least the above problems and/or disadvantages and to provide at least the advantages below. Accordingly, an aspect of the present invention is to provide an apparatus and method for synchronizing phonebook data with messages in a portable terminal.

Another aspect of the present invention is to provide an apparatus and method for changing a phone number and a name contained in sent/received messages according to a synchronization mode for synchronizing phonebook data with messages, and displaying them.

According to one aspect of the present invention, a method for synchronizing phonebook data with sent/received messages in a portable terminal includes setting a synchronization mode for synchronizing the phonebook data with the sent/received messages; detecting, from among the sent/received messages, a message corresponding to a specific phone number in a phonebook when the specific phone number is changed; and changing sending/receiving information contained in the detected message according to the set synchronization mode.

According to another aspect of the present invention, an apparatus for synchronization phonebook data with sent/received messages includes a phonebook for storing phone numbers and names; a message DataBase (DB) for storing message senders'/receivers' phone numbers and names of the sent/received messages; and a control unit for checking a synchronization mode opted by a user for synchronizing the phonebook data with the sent/received messages when a specific phone number of the phonebook is changed, detecting from the message DB a message corresponding the specific phone number to be changed, and changing sending/receiving information contained the detected message according to the checked mode.

### BRIEF DESCRIPTION OF THE DRAWINGS

The above and other aspects, features and advantages of the present invention will become more apparent from the following detailed description when taken in conjunction with the accompanying drawings in which:

FIG. 1 is a block diagram of a portable terminal according to an embodiment of the present invention; and

FIG. 2 is a flowchart illustrating a procedure for synchronizing phonebook data with received messages depending on a synchronization mode in a portable terminal according to an embodiment of the present invention.

### DETAILED DESCRIPTION OF THE PREFERRED EMBODIMENTS

Preferred embodiments of the present invention will be described herein below with reference to the accompanying drawings. In the following description, for clarity and conciseness, well-known functions or constructions are not described in detail.

The present invention provides an apparatus and method for changing a phone number and a name contained in a sent/received message according to a mode, which is opted by a user, for synchronizing phonebook data with messages, and displaying them. Although a received message is described as an embodiment of the present, the present invention can be similarly applied to a sent message.

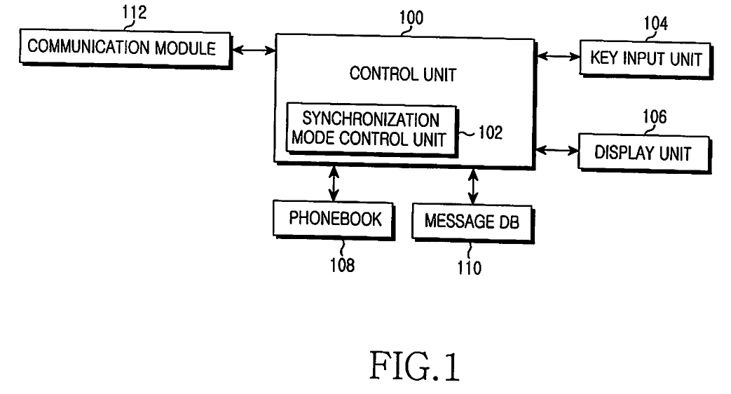

FIG. 1 is a block diagram of a portable terminal according to an embodiment of the present invention. The portable terminal includes a control unit 100 having a synchronization mode control unit 102, a key input unit 104, a display unit 106, a phonebook 108, a message DB 110, and a communication module 112. The control unit 100 may be a MicroProcessor Unit (MPU).

Referring to FIG. 1, the control unit 100 controls an overall operation of the terminal. In addition to basic functions, the control unit 100 controls and processes a function for a synchronization mode by including the synchronization mode control unit 102 when the synchronization mode is set by a user. The synchronization mode control unit 102 controls and processes a function for changing field values in the message DB 110 according to the synchronization mode when the synchronization mode is set by the user and a phone number stored in the phonebook 108 is updated. When a linking operation associated with a specific message (e.g., a reply to the specific message or a call connection) is opted by the user, the control unit 100 controls and processes a function for performing the linking operation to a phone number changed through the synchronization mode.

The key input unit 104 includes a plurality of keys for inputting numerals and letters, and a plurality of function keys for setting various functions. When any key of the key input unit 104 is pressed, the key input unit 104 sends a corresponding key signal to the control unit 100.

The display unit 106 displays state information generated during operations of the terminal and a limited number of numerals and letters. In addition, the display unit 106 displays, under the control of the control unit 100, a phone number and a name that are changed and set through the synchronization mode when a message containing the changed phone number and name is displayed.

The phonebook 108 stores a plurality of phone numbers and names input by the user. In addition, the phonebook 108 stores new phone numbers and names, or changed phone numbers and names according to the user's key input.

The message DB 110 includes a name field, an original phone number field (o_number), and a current phone number field (c_number). The name field stores a name corresponding to a sending phone number contained in a received message. The original phone number field stores an unchanged (i.e., before the change) phone number. The current phone number field stores a changed phone number. The unchanged phone number is displayed as a sending phone number of a corresponding received message.

The communication module 112 TX/RX (Transmit/Receive)-processes Radio-Frequency (RF) signals transmitted/received through an antenna. For example, in the case of transmission, the communication module 112 performs channel coding and spreading on TX data and RF-processes the resulting data prior to transmission. In the case of reception, the communication unit 112 converts received RF signals into baseband signals and performs de-spreading and channel decoding on the baseband signals to recover the original data.

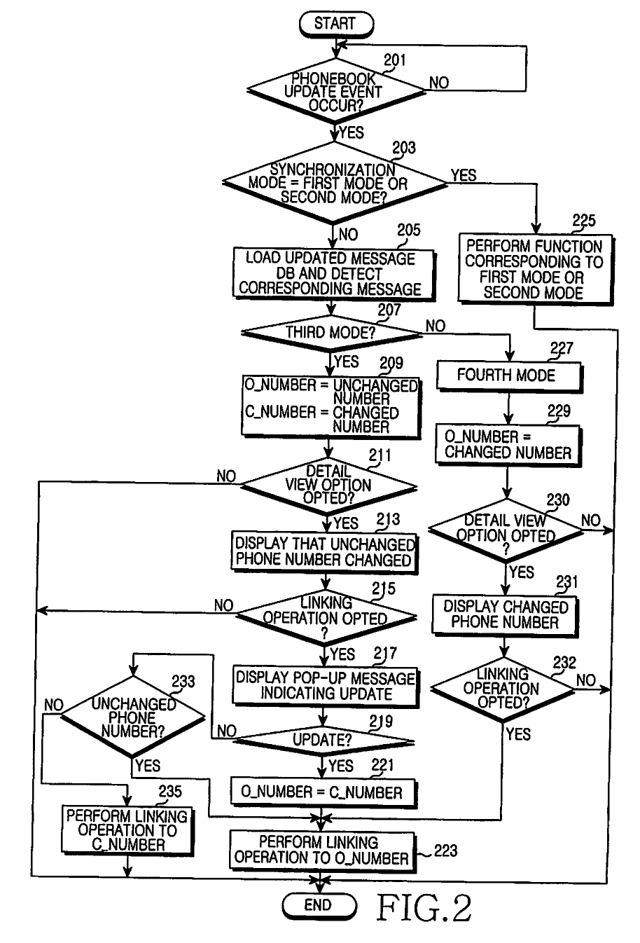

FIG. 2 is a flowchart illustrating a procedure for synchronizing phonebook data with received messages in accordance with a synchronization mode in a portable terminal according to an embodiment of the present invention.

Referring to FIG. 2, in step 201, the terminal checks whether a previously stored phone number in a phonebook (hereinafter, referred to as an unchanged phone number) was changed. When the unchanged phone number was changed, the terminal determines whether a synchronization mode is preset by a user for synchronizing the phonebook data with the received messages as one of a first mode and a second mode in step 203.

Then, the terminal performs a function corresponding to the preset synchronization mode (the first mode or the second mode) in step 225. Specifically, if the synchronization mode is the first mode, the terminal does not change information contained in the received message. However, changed phonebook data is used for displaying a new message that is received after the unchanged phone number is changed. For example, in the first mode, if A's phone number of ‘1111’ was changed into ‘2222’ on September 30, the terminal detects a message containing a sending phone number of ‘1111’ from among messages that had been received before September 30, and displays A as a sender of the detected message. The terminal detects an other message containing a sending phone number of ‘2222’ from among messages that have been received after September 30, and displays A as a sender of the other message.

If the synchronization mode is the second mode, the terminal changes previously received messages and newly received messages according to the changed phonebook data. For example, if A's phone number of ‘1111’ was changed into ‘2222’ on September 30, the terminal displays A as a sender of a message containing a sending phone number of ‘2222’ regardless of a receipt date of the message. However, a sender's name of a message containing a sending phone number of ‘1111’ is not displayed.

If the synchronization mode is not the first mode or the second mode, the terminal checks the unchanged phone number and the changed phone number and detects a message containing the unchanged phone number from the message DB 110 in step 205. The terminal determines whether the synchronization mode is a third mode in step 207.

If the synchronization mode is not the third mode, the terminal determines that the synchronization mode is a fourth mode in step 227. The terminal stores the changed phone number in an original phone number field of the detected messages in step 229. The terminal checks whether a detail view option is opted by the user in step 230. The terminal ends the procedure when the detail view option is not opted. When the detail view option is opted, the changed phone number is displayed on an area that displays a sending phone number in the detected message in step 231. For example, if A's phone number of ‘1111’ was changed into ‘2222’ on September 30, the terminal may display A as a sender of the detected message by changing a sending phone number to ‘2222’ from ‘1111’ contained in the detected message which had been received before September 30.

Thereafter, the terminal determines whether a linking operation is opted by the user in step 232. The terminal ends the procedure when the linking operation is not opted. When the linking operation is opted, the terminal performs the linking operation to the changed phone number in step 223. Thereafter, the terminal ends the procedure.

If the synchronization mode is the third mode, the terminal stores the unchanged phone number in the original phone number field of the detected message in the message DB 110, and the changed phone number in the current phone number field in step 209. The terminal determines whether a detail view option is opted by the user in step 211. The terminal ends the procedure when the detail view option is not opted.

When the detail view option is opted, the terminal displays the unchanged phone number on an area that displays a sending phone number, and displays that the unchanged phone number is changed in step 213. For example, if A's phone number of ‘1111’ was changed into ‘2222’ on September 30, the terminal detects a message containing a sending phone number of ‘1111’ that had been received before September 30 and then shades the sending phone number of ‘1111’ in order to inform that the sending phone number was changed. Also, the color, thickness, or shape of the sending phone number can be changed.

Thereafter, the terminal determines whether a linking operation (e.g., a reply to a received message or a call connection) is opted by the user in step 215. The terminal ends the procedure when the linking operation is not opted.

When the linking operation is opted, the terminal displays a pop-up message to ask the user whether the user opts changing the unchanged phone number into the changed phone number in step 217. The terminal checks whether the user opts changing the unchanged phone number into the changed phone number in step 219. When the user does not opt changing the unchanged phone number into the changed phone number, the terminal checks whether the user opts performing the linking operation to the unchanged phone number in step 223. When the user opts performing the linking operation to the unchanged phone number, the terminal performs the linking operation to the unchanged phone number in step 235. On the other hand, when the user does not opt performing the linking operation to the unchanged phone number, the terminal performs the linking operation to the changed phone number in step 235. Thereafter, the terminal ends the procedure.

When, in step 219, the user opts changing the unchanged phone number into the changed phone number, the terminal stores the changed phone number in the original phone number field in step 221. The terminal performs the linking operation to the changed phone number stored in the current phone number field. Thereafter, the terminal ends the procedure.

As described above, in the portable terminal according to the present invention, the synchronization mode is set by the user. The user changes, according to the set synchronization mode, sending/receiving information of a sent/received message that contains a specific phone number as a sending phone number when the specific phone number of the phonebook is changed. Thus, the user can changes a phone number and a name of the sent/received message properly. When a linking operation is opted, the user can conventionally use the sending/receiving information according to the synchronization mode.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (e.g., transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for synchronizing phonebook data with sent/received messages in a portable terminal, comprising the steps of:
setting a synchronization mode for synchronizing the phonebook data with the sent/received messages;
detecting from among the sent/received messages, a message corresponding to a specific phone number in a phonebook when the specific phone number was changed; and
changing sending/receiving information contained in the detected message according to the set synchronization mode.

2. The method of claim 1, wherein the sending/receiving information comprises at least one of a message sender's phone number and name.

3. The method of claim 1, wherein, when the set synchronization mode is a first mode, the step of changing the sending/receiving information comprises changing a sending phone number contained in the detected message into the changed phone number.

4. The method of claim 1, wherein, when the set synchronization mode is a second mode, the step of changing the sending/receiving information comprises displaying that a sending phone number or a receiving phone number contained in the detected message is changed when a detail view option is opted.

5. The method of claim 4, wherein the step of displaying comprises displaying that at least one of a color, a shape, and a thickness of the sending phone number or the receiving phone number is changed.

6. The method of claim 4, further comprising displaying a message to ask a user whether the user opts changing the sending phone number contained in the detected message into the changed phone number when the user opts a linking operation associated with the detected message.

7. The method of claim 6, when the user opts changing the sending phone number into the changed phone number, further comprising:
changing the sending phone number into the changed phone number; and
performing the opted operation for the changed phone number.

8. The method of claim 6, when the user does not opt to change the sending phone number into the changed phone number, further comprising:
displaying a message to ask the user whether the user opts performing the opted operation for the sending phone number; and
performing the opted operation for the sending phone number when the user opts performing the opted operation for the sending phone number.

9. The method of claim 8, further comprising performing the opted operation for the changed phone number when the user does not opt to perform the opted operation for the sending phone number.

10. An apparatus for synchronization phonebook data with sent/received messages, comprising:
a phonebook for storing phone numbers and names;
a message DataBase (DB) for storing message senders'/receivers' phone numbers and names of the sent/received messages; and
a control unit for checking a synchronization mode opted by a user for synchronizing the phonebook data with the sent/received messages when a specific phone number of the phonebook was changed, detecting from the message DB a message corresponding to the specific phone number to be changed, and changing sending/receiving information contained the detected message according to the checked mode.

11. The apparatus of claim 10, wherein the sending/receiving information comprises at least one of a message sender's phone number and name.

12. The apparatus of claim 10, wherein, when the checked synchronization mode is a first mode, the control unit changes a sending phone number contained the detected message into the changed phone number.

13. The apparatus of claim 10, wherein, when the checked synchronization mode is a second mode, the control unit displays that a sending or receiving phone number of the detected message was changed when a detail view option is opted.

14. The apparatus of claim 13, wherein the control unit displays a message to ask a user whether the user opts changing the sending phone number contained in the detected message into the changed phone number when the user opts a linking operation associated with the detected message.

15. The apparatus of claim 14, wherein, when the user opts changing the sending phone number into the changed phone number, the control unit changes the sending phone number into the changed phone number and performs the opted operation for the changed phone number.

16. The apparatus of claim 14, wherein, when the user does not opt changing the sending phone number into the changed phone number, the control unit checks which one of the sending number or the changed phone number is opted by the user for the opted operation, and performs the opted operation for the opted phone number.

17. An apparatus for synchronizing phonebook data with sent/received messages in a portable terminal, comprising:
means for setting a synchronization mode for synchronizing the phonebook data with the sent/received messages;
means for detecting from among the sent/received messages, a message corresponding to a specific phone number in a phonebook when the specific phone number was changed; and
means for changing sending/receiving information contained in the detected message according to the set synchronization mode.

18. A computer-readable recording medium having recorded thereon program for synchronizing phonebook data with sent/received messages in a portable terminal, comprising:
a first code segment for setting a synchronization mode for synchronizing the phonebook data with the sent/received messages;
a second code segment for detecting, from among the sent/received messages, a message corresponding to a specific phone number in a phonebook when the specific phone number was changed; and
a third code segment for changing sending/receiving information contained in the detected message according to the set synchronization mode.
